(19) United States
(12) Patent Application Publication
(10) Pub. No.: US 2010/0051432 A1
(43) Pub. Date: Mar. 4, 2010

(54) Membrane type computer keyboard

(75) Inventors: Yu Kai Lin, Taipei Hsien (TW); Yi Hung Lin, Taipei Hsien (TW); Chih Yung Chen, Taipei Hsien (TW)

Correspondence Address: CHARLES E. BAXLEY, ESQUIRE, 90 JOHN STREET, SUITE 309, NEW YORK, NY, 10038, US

(73) Assignee: Goda Technology Co., Ltd.

(21) Appl. No.: 12/231,613

(22) Filed: Sep. 4, 2008

(51) Int. Cl. H01H 13/72; H01H 1/10

(52) U.S. Cl. 200/5 A; 200/512

(57) ABSTRACT

A computer keyboard includes a base membrane and a upper membrane each having a number of electric contacts aligned with each other, a spacer layer disposed between the membranes for separating the contacts of the membranes from each other and having a number of openings aligned with the contacts of the membranes for allowing the contacts of the upper membrane to be actuated to engage with the contacts of the base membrane, and a number of symbols aligned with the contacts of the membranes for indicating the contacts of the membranes. A graphic overlay is attached onto the upper membrane, and the symbols are applied onto the graphic overlay or applied onto the base membrane.

### BACKGROUND OF THE INVENTION

1. Field of the Invention

The present invention relates to a computer keyboard, and more particularly to a computer keyboard including a spacer layer disposed between two sheets or membranes for separating the electric circuits of the membranes from each other and for allowing the actuators or contacts of the electric circuits of the membranes to be selectively depressed and contacted with each other and for allowing the computer keyboard to include a greatly reduced thickness.

2. Description of the Prior Art

Typical computer keyboards comprise a membrane, and a number of actuators and contact inserts to be depressed and actuated by key switches or key caps in order to engage or to contact with the actuators or contacts of the membrane and so as to electrically couple the electric circuits of the membrane together and to generate signals.

For example, U.S. Pat. No. 6,322,229 to Chan et al. discloses one of the typical computer keyboards comprising a number of actuating members each coupled to a key switch or key cap with a stem and depressible and actuatable by the key switches or key caps in order to engage or to contact with the actuators or electric contacts of a membrane.

However, the stems and the key switches or key caps and the actuating members comprise a great height or thickness such that the typical computer keyboards may comprise a greatly increased dimension or volume that is adverse for compact mobile devices such as the portable computer.

The present invention has arisen to mitigate and/or obviate the afore-described disadvantages of the conventional computer keyboards.

### SUMMARY OF THE INVENTION

The primary objective of the present invention is to provide a computer keyboard with greatly reduced thickness that includes a spacer layer disposed between two sheets or membranes or membrane layers for separating the electric circuits of the membranes from each other and for allowing the actuators or contacts of the electric circuits of the membranes to be selectively depressed and contacted with each other.

In accordance with one aspect of the invention, there is provided a computer keyboard comprising a first membrane including an electric circuit having a number of contacts, a second membrane disposed above the first membrane and including an electric circuit having a number of contacts, the contacts of the second membrane being aligned with the contacts of the first membrane and disposed above the contacts of the first membrane and facing toward the contacts of the first membrane for being actuated to selectively engage with the contacts of the first membrane, a spacer layer disposed between the first and the second membranes for separating the electric circuits of the first and the second membranes, and including a number of openings formed therein and aligned with the contacts of the first and the second membranes for allowing the contacts of the second membrane to be selectively actuated through the openings of the spacer layer and to engage with the contacts of the first membrane, and a number of symbols aligned with the contacts of the first and the second membranes for indicating the contacts of the first and the second membranes and for allowing the computer keyboard to include a greatly reduced thickness.

A graphic overlay is further provided and attached onto the second membrane, and the symbols are applied onto the graphic overlay. The graphic overlay may include a pattern applied thereon for indicating the symbols of the graphic overlay, and/or for separating the symbols from each other.

Alternatively, the symbols may also be directly applied onto the first membrane without the graphic overlay, and the first membrane may also include a pattern applied thereon for indicating the symbols of the first membrane, and/or for separating the symbols from each other.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of a computer keyboard in accordance with the present invention;

FIG. 2 is an exploded view of the computer keyboard;

FIG. 3 is a cross sectional view of the computer keyboard taken along lines 3-3 of FIG. 1;

FIG. 4 is a cross sectional view similar to FIG. 3, illustrating the operation of the computer keyboard;

FIG. 5 is a cross sectional view similar to FIGS. 3 and 4, illustrating the other arrangement of the computer keyboard;

FIG. 6 is a cross sectional view similar to FIG. 5, illustrating the operation of the computer keyboard as shown in FIG. 5;

FIG. 7 is a perspective view illustrating a graphic overlay of the computer keyboard; and

FIG. 8 is a perspective view similar to FIG. 7, illustrating the further embodiment of the graphic overlay of the computer keyboard.

### DETAILED DESCRIPTION OF THE PREFERRED EMBODIMENT

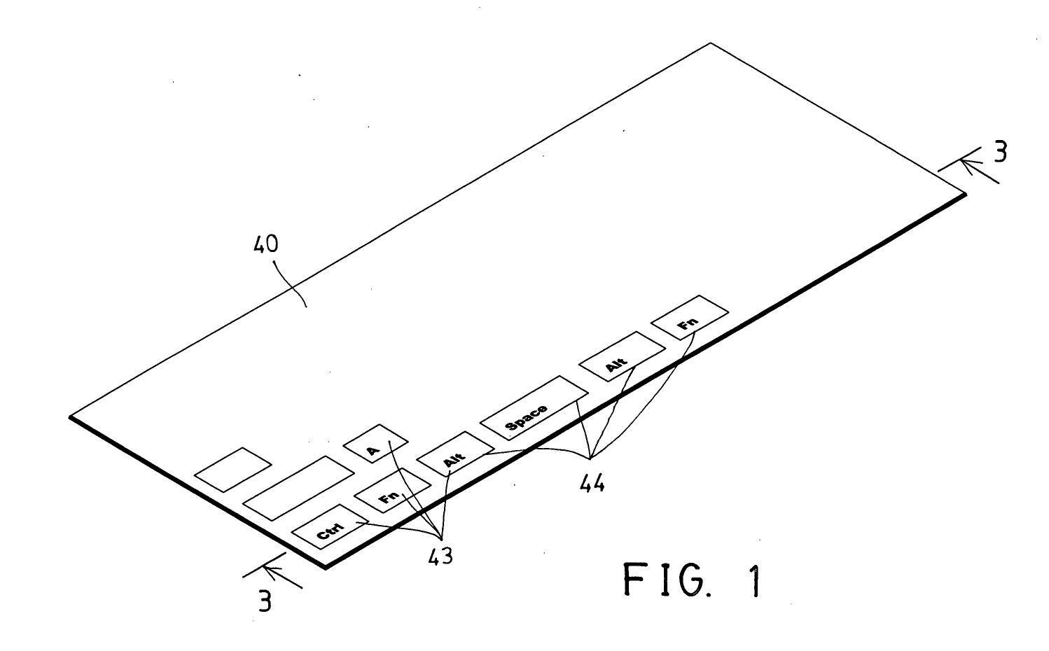

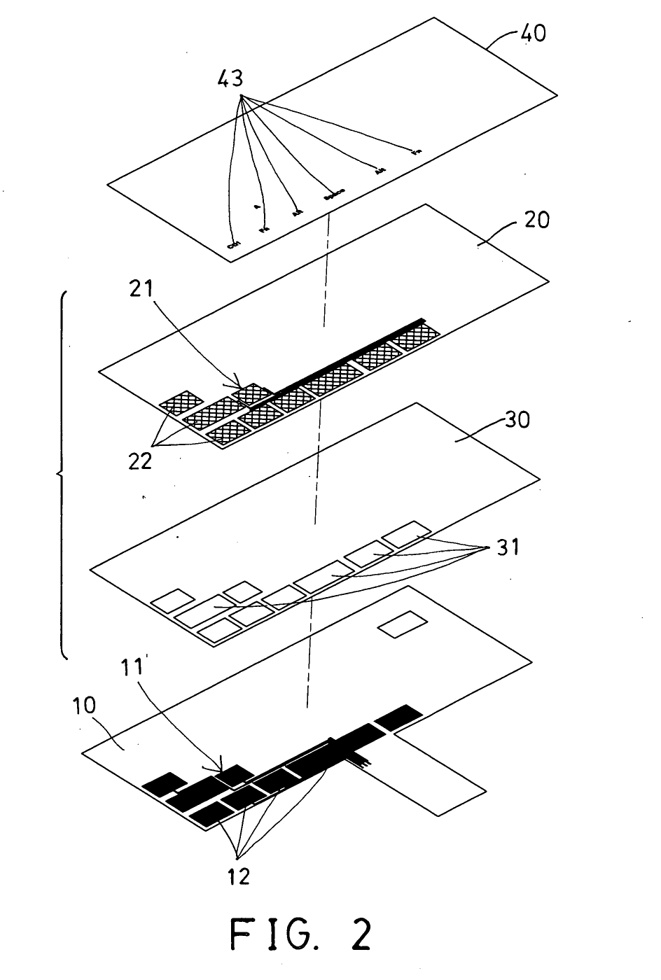

Referring to the drawings, and initially to FIGS. 1-3, a computer keyboard in accordance with the present invention comprises a base or first membrane 10 including an electric circuit 11 having a number of contacts 12, an upper or second membrane 20 disposed above the first membrane 10 and also including an electric circuit 21 having a number of contacts 22 printed or applied to the bottom portion of the second membrane 20 and aligned with the contacts 12 of the first membrane 10 and also disposed above the contacts 12 of the first membrane 10 and facing toward the contacts 12 of the first membrane 10 for being depressed or actuated to selectively engage or contact with the electric contacts 12 of the first membrane 10.

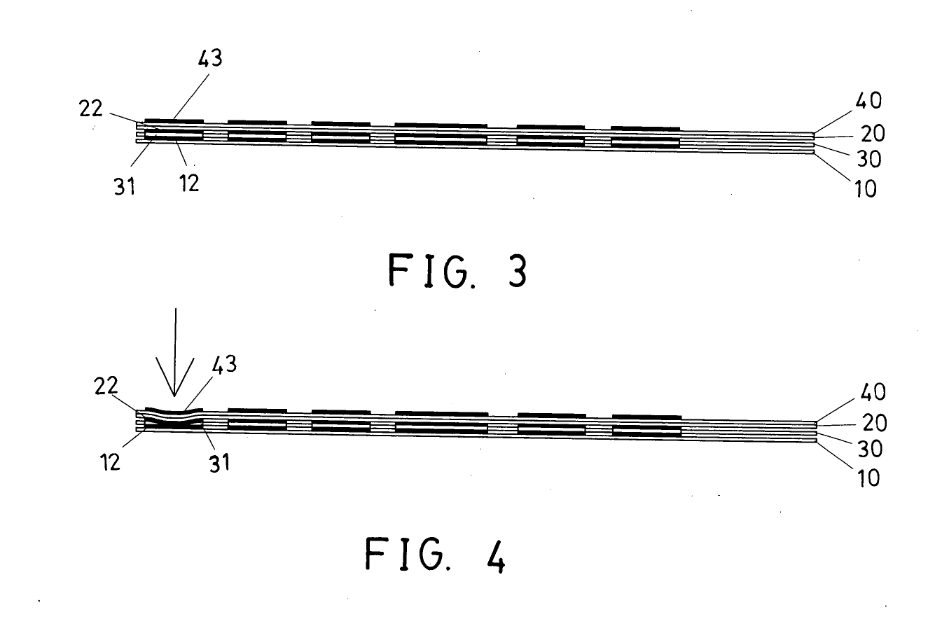

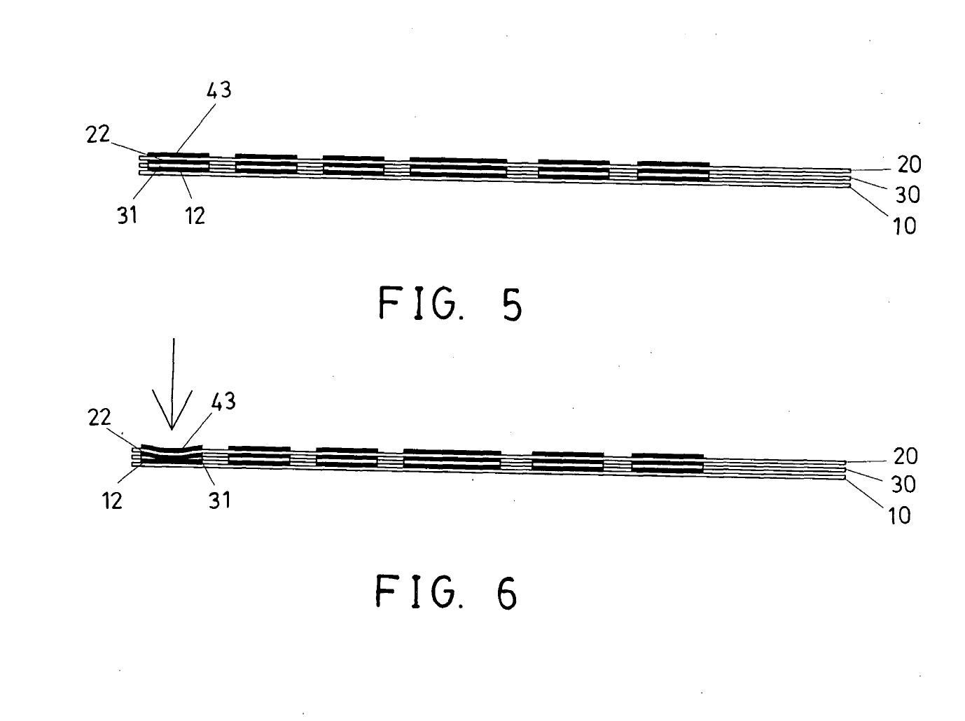

A spacer layer 30 is disposed between the membranes 10, 20 for suitably separating the electric circuits 12, 22 of the membranes 10, 20 from each other (FIGS. 3, 5), and includes a number of openings 31 formed therein and aligned with the contacts 12, 22 of the membranes 10, 20 for allowing the contacts 22 of the second membrane 20 to be selectively depressed or actuated through the openings 31 of the spacer layer 30 and to engage or contact with the contacts 12 of the first membrane 10, best shown in FIGS. 4 and 6, and for allowing the electric circuits 11, 21 of the membranes 10, 20 to be selectively and electrically coupled together and to generate signals.

The computer keyboard further includes a graphic overlay 40 attached or secured onto the upper portion of the upper or second membrane 20 and having a number of words or symbols 43 applied thereon by typing, painting, or printing processes, for example, and aligned with the contacts 12, 22 of the membranes 10, 20 for indicating the relative contacts 12, 22 of the membranes 10, 20, and the graphic overlay 40 further includes a number of boxes or patterns 44 applied thereon (FIG. 1) by typing, painting, or printing processes, for example, for separating the symbols 43 from each other, and/or for indicating the symbols 43 of the graphic overlay 40, and/or for simulating the shapes of the typical computer keyboards. The graphic overlay 40 and the membranes 10, 20 may be solidly secured together with ultrasonic welding procedures, for example.

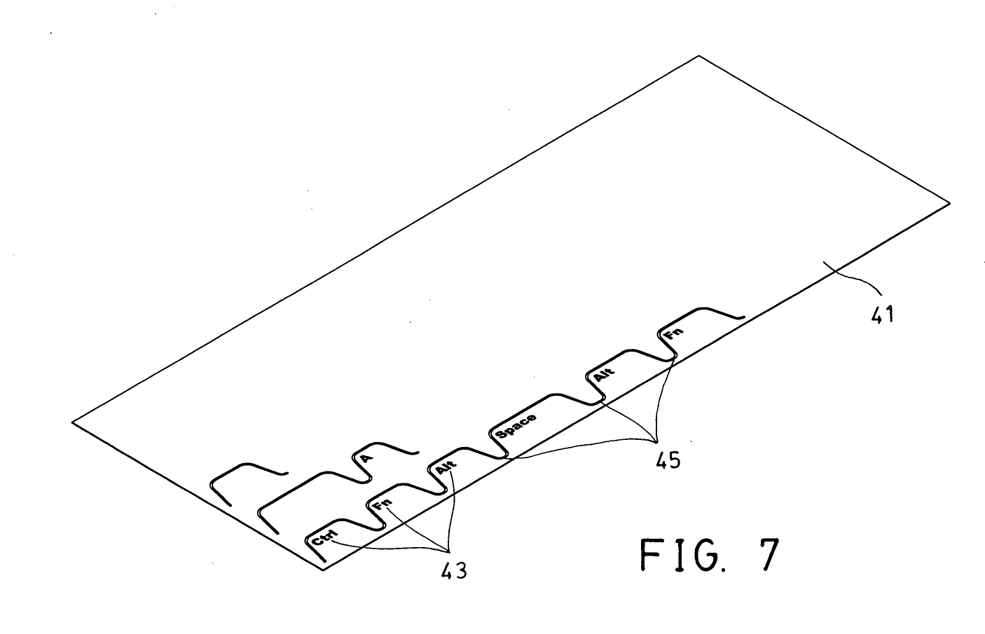

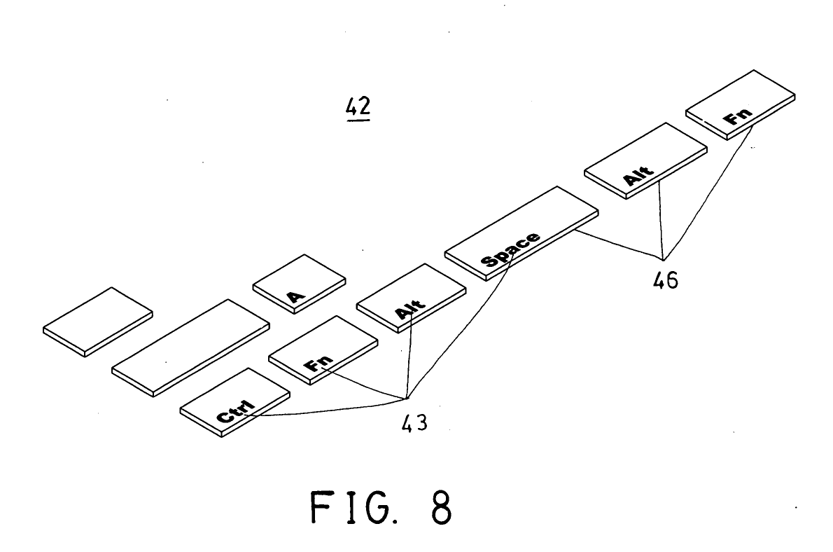

Alternatively, as shown in FIGS. 7 and 8, the patterns 45, 46 applied onto the graphic overlays 41, 42 may include different shapes or contours or configurations. It is to be noted that the symbols 43 and the patterns 44, 45, 46 are applied onto the graphic overlays 40, 41, 42 by typing, painting, or printing processes such that the graphic overlays 40, 41, 42 may include a greatly reduced or decreased height or thickness. Alternatively, as shown in FIGS. 5 and 6, without the graphic overlays 40, 41, 42, the symbols 43 and the patterns may also be directly applied onto the upper portion of the upper or second membrane 20 for further reducing or decreasing the height or thickness of the computer keyboard.

In operation, as shown in FIGS. 4 and 6, when either of the symbols 43 of the graphic overlay 40-42 is depressed or actuated by the user, the respective contacts 22 of the second membrane 20 may be selectively depressed or actuated through the openings 31 of the spacer layer 30 and to engage or contact with the contacts 12 of the first membrane 10, and for allowing the electric circuits 11, 21 of the membranes 10, 20 to be selectively and electrically coupled together and to generate the required or selected signals which will be transmitted to the computer (not shown).

Accordingly, the computer keyboard in accordance with the present invention includes a spacer layer disposed between two sheets or membranes or membrane layers for separating the electric circuits of the membranes from each other and for allowing the actuators or contacts of the electric circuits of the membranes to be selectively depressed and contacted with each other and for allowing the computer keyboard to include a greatly reduced thickness.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A computer keyboard comprising:
a first membrane including an electric circuit having a plurality of contacts,
a second membrane disposed above said first membrane and including an electric circuit having a plurality of contacts, said contacts said second membrane being aligned with said contacts of said first membrane and disposed above said contacts of said first membrane and facing toward said contacts of said first membrane for being actuated to selectively engage with said contacts of said first membrane,
a spacer layer disposed between said first and said second membranes for separating said electric circuits of said first and said second membranes from each other, and including a plurality of openings formed therein and aligned with said contacts of said first and said second membranes for allowing said contacts of said second membrane to be selectively actuated through said openings of said spacer layer and to engage with said contacts of said first membrane, and
a plurality of symbols aligned with said contacts of said first and said second membranes for indicating said contacts of said first and said second membranes.

2. The computer keyboard as claimed in claim 1 further comprising a graphic overlay attached onto said second membrane, and said symbols are applied onto said graphic overlay.

3. The computer keyboard as claimed in claim 2, wherein said graphic overlay includes a pattern applied thereon for indicating said symbols of said graphic overlay.

4. The computer keyboard as claimed in claim 1, wherein said symbols are applied onto said first membrane.

5. The computer keyboard as claimed in claim 4, wherein said first membrane includes a pattern applied thereon for indicating said symbols of said first membrane.
